(19) United States
(12) Patent Application Publication
(10) Pub. No.: US 2008/0014553 A1
(43) Pub. Date: Jan. 17, 2008

(54) Dental instrument

(76) Inventors: Tom Garrison, Spring Lake, MI (US); John E. Garrison, Spring Lake, MI (US); Robert Anderson, Coopersville, MI (US); Scott Doenges, West Olive, MI (US); Schuyler VanGorden, Eau Claire, WI (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/453,281

(22) Filed: Jun. 14, 2006

Related U.S. Application Data
(60) Provisional application No. 60/690,424, filed on Jun. 14, 2005.

(51) Int. Cl. A61C 3/08

(52) U.S. Cl. 433/164

(57) ABSTRACT

A dental instrument comprising a handle member, a first tool assembly and a second tool assembly. The handle member includes a barrel, a tapered first end and a tapered second end. The first tool assembly comprises a first tool arm, a burnisher extending from the first tool arm, a first plugger element extending from the burnisher and a second tool arm extending from the burnisher. The second tool assembly comprises a second tool arm, a blade member extending from the second tool arm and an acorn carver extending from at least one of the second tool arm and the blade member.

### CROSS REFERENCE TO RELATED APPLICATION

This application claims priority to U.S. Provisional Patent Application Ser. No. 60/690,424 filed Jun. 14, 2005, and entitled “Dental Instrument,” the entire disclosure of which is incorporated herein by reference.

### BACKGROUND OF THE INVENTION

1. Field of the Invention

The present invention relates in general to dental instruments, and more particularly to a dental instrument which includes a number of tools attached thereto.

2. Background Art

Dental instruments for filling cavities, for example, have been known in the art. One example of such an instrument is shown in U.S. Pat. No. 4,643,677 issued to Kim. While this instrument has combined several dental tools, it nevertheless has drawbacks.

Among other drawbacks, certain of the instruments are difficult to manipulate in their current position and configuration. Second, certain instruments which are utilized in conjunction with the tools that are in present in the tool must be separately utilized. The dental practitioner must often reach for other instruments. In the end, the dental practitioner is nevertheless faced with changing instruments within a restoration. Thus, while the instruments of the prior art increase efficiency, there is still a large gap inasmuch as the instrument set is quite incomplete.

Additionally, the shape of certain of the instruments is much less than ideal. In particular, the pluggers comprise uniform cylinders or outwardly conical configurations with a right angle end which can undesirably cause air pockets to develop within the restoration. Furthermore, due to the geometric configuration, the pluggers are generally usable only for the condensing of composite. Moreover, the burnishers are likewise susceptible to instrument interference.

Thus, it is an object of the present invention to improve the position and function of a dental instrument.

It is another object of the invention to provide additional instruments which form a set of commonly utilized tools for certain dental procedures.

It is another object of the invention to enhance the configuration of the instruments to lessen tool interference.

It is another object of the invention to provide an enhanced configuration to plugger elements.

These and other objects of the invention will become apparent in light of the specification and claims appended hereto.

### SUMMARY OF THE INVENTION

The invention comprises a dental instrument comprising a handle member, first tool assembly and a second tool assembly. The handle member has a first and second end. The first tool assembly is positioned at the first end and the second tool assembly positioned at the second end. The first tool assembly and the second tool assembly collectively include at least five separate dental tools.

In a preferred embodiment, the dental tools are selected from the group consisting of: burnishers, plugger elements, acorn carvers, and blades.

In another preferred embodiment, the first tool assembly further comprises a plurality of plugger elements.

In one such embodiment, at least one of the plugger elements includes a first end extending from the handle member and a second end spaced apart from the handle member. At least a portion of the plugger element has an outwardly conical configuration proximate the first end of the plugger element and at least a portion of the plugger element has an inwardly conical region proximate the second end of the plugger element. As such, the plugger elements transitions from an outwardly conical configuration to an inwardly conical configuration along the length thereof.

In one such embodiment, the plugger element terminates with a convex cap at the second end thereof. In other embodiments, the plugger element can terminate with a flat cap member.

In one preferred embodiment, the outwardly conical configuration comprises approximately 30% to 60% of the length of the plugger element, and the inwardly conical configuration comprises approximately 40% to 70% of the length of the plugger element.

In another embodiment, two plugger elements are contemplated wherein each plugger element has an outwardly conical portion and an inwardly conical portion. It is contemplated that the two plugger elements define a plane and they are angled relative to each other in that plane approximately between 65° and 125°.

In another preferred embodiment, a first of the two plugger elements has an inwardly conical region which at a largest diameter is smaller than the diameter of the inwardly conical region of a second of the two plugger elements at a largest diameter.

In another embodiment, one of a burnisher and an acorn carver is positioned at a base of the two plugger elements, wherein the two plugger elements extend away from same.

In yet another preferred embodiment, the first tool assembly further comprises a first tool arm extending from the handle. The first tool arm has a first segment and a second segment. The first segment is angled relative to the handle member and the second segment is angled relative to the first segment.

In another preferred embodiment, the handle member, the first segment and the second segment of the first tool arm define a plane, distinct from a plane defined by either of the two plugger elements.

Preferably, the second tool assembly further comprises a blade. In one such embodiment, the second tool assembly further comprises one of an acorn carver and a burnisher positioned at a base of the blade.

In a preferred embodiment, the blade defines a plane which is oblique to the planes defined by any one of the plurality of plugger elements.

In another aspect of the invention, the invention comprises a handle member and at least one plugger element. The at least one plugger element comprising a first end extending from the handle member and a second end spaced apart from the handle member. At least a portion of the plugger element has an outwardly conical configuration proximate the first end thereof and at least a portion of the plugger element has an inwardly conical region proximate the second end thereof.

In a preferred embodiment, the at least one plugger element terminates with a convex cap at the second end thereof.

In another preferred embodiment, the outwardly conical configuration comprises approximately 30% to 60% of the length of the plugger element, and the inwardly conical configuration comprises approximately 40% to 70% of the length of the plugger element.

In yet another aspect of the invention, the invention comprises a dental instrument comprising a handle member having a first end and a first tool assembly extending from the first end. The first tool assembly comprising at least two plugger elements, the at least two plugger elements extending away from each other, wherein each plugger element can be selectively used by a user substantially without interference from the other plugger element.

In a preferred embodiment, the first tool assembly includes a first tool arm extending from the handle member, wherein a plane defined by the at least two plugger elements is oblique to the plane defined by the handle member and the first tool arm.

### BRIEF DESCRIPTION OF THE DRAWINGS

The invention will now be described with reference to the drawings wherein:

FIG. 1 of the drawings comprises a perspective view of the dental instrument of the present invention;

FIG. 2 of the drawings comprises a top plan view of the dental instrument of the present invention;

FIG. 3 of the drawings comprises a side elevational view of the dental instrument of the present invention;

FIG. 4 of the drawings comprises a partial perspective view of the dental instrument of the present invention, showing in particular the first tool assembly; and

FIG. 5 of the drawings comprises a partial perspective view of the dental instrument of the present invention, showing in particular the second tool assembly.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

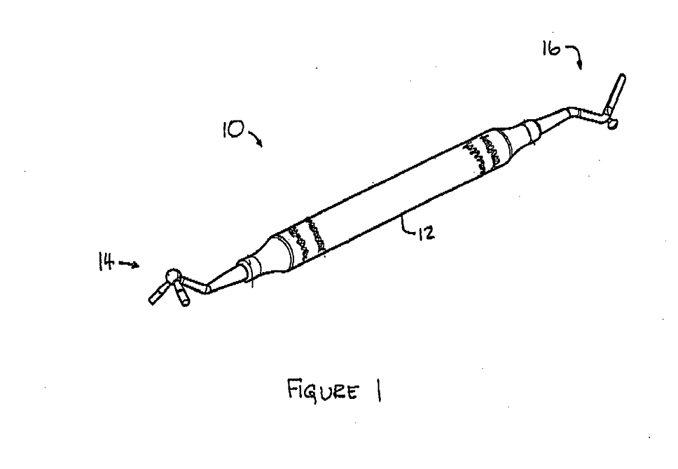

Referring now to the drawings and in particular to FIG. 1, the dental instrument of the present invention is shown generally at 10. The dental instrument includes handle member 12, first tool assembly 14, and second tool assembly 16. The first tool assembly is positioned at one end of the handle member and the second tool assembly is positioned at the other end of the handle member. The dental instrument is generally formed from a stainless steel member which is capable of withstanding the heat generated by autoclaving sterilization machines or dry-heat sterilization. It is contemplated that other materials may be utilized, certain of which materials are capable of surviving sterilization, and others which are more suited for disposable operation.

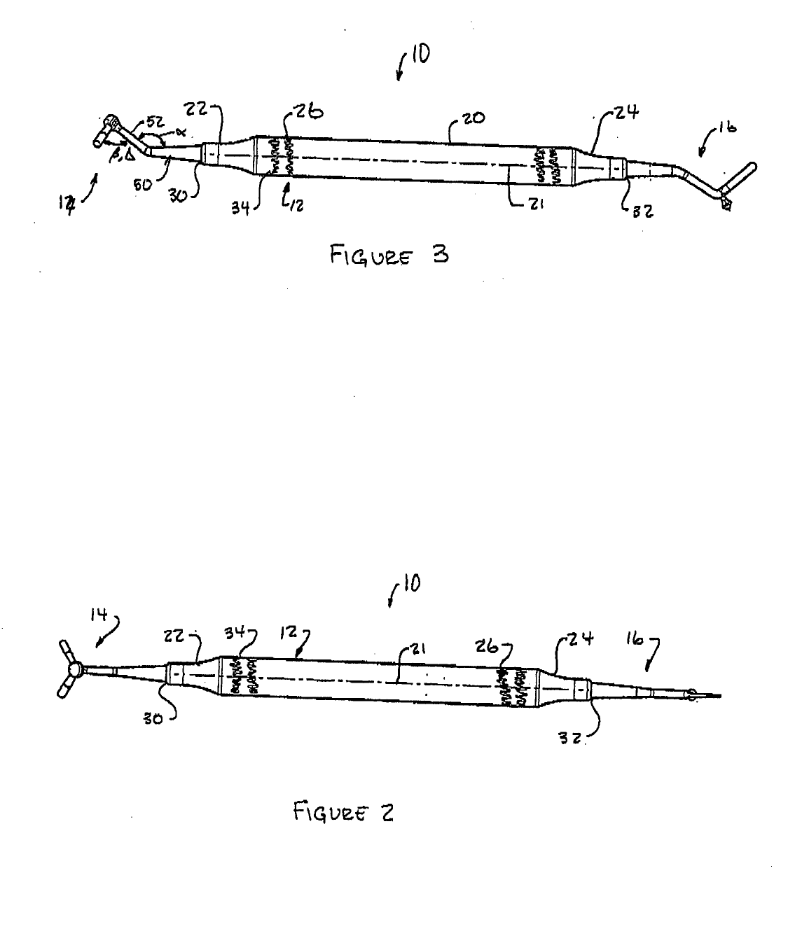

With reference to FIGS. 2 and 3, handle member 12 includes barrel 20, tapered first end 22, tapered second end 24 and means 26 for facilitating the gripping of the handle member by a user, such as a dental practitioner. The barrel is elongated and defines longitudinal axis 21. In the embodiment shown, the barrel has a substantially uniform circular cross-sections, so as to define a narrow elongated cylinder. In other embodiments, the barrel may comprise a polygonal cross-section, such as, for example, a hexagonal or octagonal configuration. In yet other embodiments, the barrel may be a non-uniform configuration wherein the cross-section is of a varying configuration.

The tapered first end generally comprises an outwardly conical configuration which terminates with tool attachment region 30. In the present embodiment, the tapered configuration includes a curved outwardly conical configuration which terminates with a substantially flat tool attachment region. The tapered second end generally comprises a configuration which is much like that of the tapered first end, and terminates at tool attachment region 32. In the present embodiment, the configuration is substantially identical so that the user is able to become accustom to operating either end of the handle member. Of course, in other embodiments, it is contemplated that the tapered ends may be of different configurations—to accommodate the special needs of a particular desired utilization.

Gripping means 26 includes a plurality of serrations 34 which are positioned strategically along the barrel at points wherein a dental practitioner would grasp the barrel to utilize any one of the tools. In other embodiments, other gripping means are contemplated; such gripping means may comprise changes in surface configuration (and cross-section), coatings such as a rubberized coating or cover over portions of the barrel, etc.

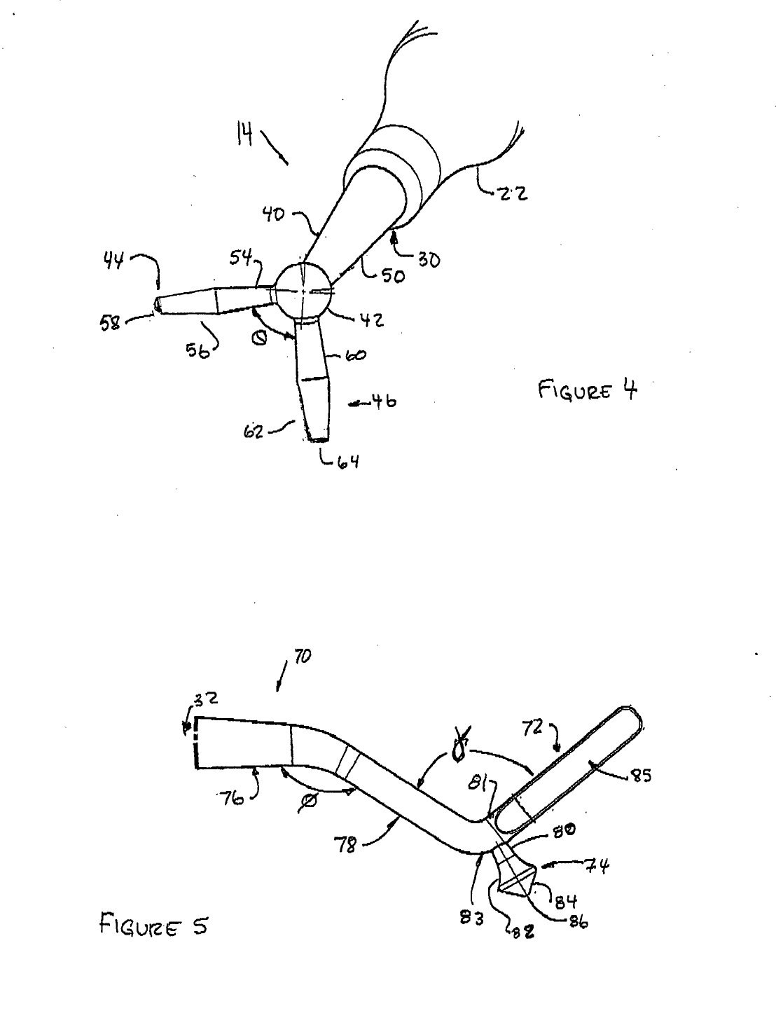

First tool assembly 14 is shown in FIG. 1, and in greater detail in FIG. 4, as comprising first tool arm 40, burnisher 42, first plugger element 44 and second plugger element 46. The first tool arm 40 includes first segment 50 and second segment 52 (FIG. 3). As is shown in FIG. 3, first segment 50 extends from tool attachment region 30 of tapered first end 22. The first segment extends generally along longitudinal axis 21, however it is contemplated that it may be disposed at an angle (a) (FIG. 3) relative to longitudinal axis 21. Second segment 52 extends from the end of first segment 50 and is disposed at an angle relative to first segment 50. The second segment is angled at approximately 45° relative to first segment 50. In other embodiments the first and second segments can be angled relative to each other at an angle of between approximately 25° and 75°. In the present embodiment, the second segment is shorter than the first segment, however, it is contemplated that the relative lengths of the various segments may be varied within the scope of the present invention.

Burnisher 42 comprises a substantially spherical member which is positioned at the distal end of second segment 52 of the first tool arm. The burnisher has a diameter of between 2 mm and 4 mm. In the embodiment contemplated, the burnisher may comprise a substantially uniform sphere, whereas in other embodiments, the configuration may be varied so that it is generally spherical over a certain arcuately defined surface area.

First plugger element 44 extends outwardly from burnisher 42. The first plugger element includes outwardly conical region 54, inwardly conical region 56 and convex cap 58. The outwardly conical region is outwardly conical and has a relative length of approximately 30% to 60% of the overall length of the first plugger element. Generally, the outwardly conical region will terminate at a radius which is about 20% to 65% that of burnisher 42. The inwardly conical region is substantially uniformly inwardly conical (although variations are contemplated), and comprises between 40% and 70% of the total length of the first plugger element. Typically, the inwardly conical region may taper at, for example, 0.5° to 8°, and may be different or the same as the taper of the outwardly conical region. The convex cap precludes presence of flat surfaces at the end of the first plugger element. In certain embodiments, although less advantageous, the convex cap may be replaced with a substantially flat cap. Preferably, the first plugger element is shorter than second segment 52 in length.

The overall construction of the first plugger element facilitates the proper application of filler material with the convex cap, proper contact with the filler material with the inwardly conical region, while permitting the movement of the device and the unobtrusiveness of the device with the outwardly conical region proximate the burnisher. Unlike the prior art instruments wherein the plugger is limited to use as a condenser of composite, the plugger of the present invention can be utilized as a burnisher, a condenser of composite or an instrument that can be used as a contact former. While not as advantageous for use as a contact former, in certain embodiments the inwardly conical configuration may be cylindrical.

Second plugger 46 includes outwardly conical region 60, inwardly conical region 62 and convex cap 64. The relative configuration of the second plugger is substantially identical to that of the first plugger, however the second plugger has a larger radial dimension in each of the outwardly conical regions and the inwardly conical regions. Thus, the second plugger is well suited for larger dental cavities, whereas the first plugger is well suited for smaller dental cavities.

The first plugger and second segment 52 of the first tool arm 40 define a plane. Within this plane, the first plugger and the second segment are angled at a range of angles (β) (FIG. 3) between 65° and 115°, most preferably, approximately 90° relative to each other. Similarly, the second plugger and second segment 52 of the first tool arm 40 define a plane. Within this plane, the second plugger and the second segment are angled at a range of angles (Δ) (FIG. 3) between 65° and 115°, and most preferably, approximately 90°. Finally, the two plugger elements 44, 46 define a third plane. Within this plane, the first plugger element and the second plugger element are angled relative to each other at a range of angles (θ) (Figure) between 65° and 125°, and most preferably, approximately 90°. Inasmuch as the separation between the above-described structures in any one of the three planes is approximately 90° the third plane is substantially orthogonal relative to the other two planes.

Second tool assembly is shown in FIG. 1, and in more detail in FIG. 5, as comprising second tool arm 70, blade member 72 and acorn carver 74. The second tool arm 70 includes first segment 76 and second segment 78. The first segment 76 extends from tool attachment region 32 of tapered second end 24 (FIG. 3). The first segment extends generally along longitudinal axis 21, however it is contemplated that it may be disposed at an angle relative to longitudinal axis 21. Second segment 78 extends from the end of first segment 76 and is disposed at an angle relative to first segment. The second segment is angled at an angle (φ) (Figure) of approximately 45° relative to first segment 76. In other embodiments the first and second segments can be angled relative to each other at an angle of between approximately 25° and 75°. In the present embodiment, the second segment is shorter than the first segment, however, it is contemplated that the relative lengths of the various segments may be varied within the scope of the present invention.

Blade member 72 extends from second segment 78 and includes tapering region 81 and flattened region 85. The blade member is angled relative to the second segment at an angle (γ) which ranges between 85° and 125°, and most preferably at an angle of approximately 110°. Acorn carver extends from back side region 83 proximate the interface between the second segment 78 and blade member 72. The acorn carver includes first region 80, second region 82, third region 84 and cap 86. The first region comprises an outwardly outwardly conical region which blends into a more aggressive, and generally non-uniform outwardly conical region which defines second region 82. The second region 82 blends into an inwardly outwardly conical region which defines third region 84. Finally, cap 86 comprises a substantially flattened region at the distal end of the acorn member. The radius of the flattened region is substantially smaller than any of the radial dimensions of the first region, second region or third region.

Advantageously, the single instrument provides the dental practitioner with a number of different tools in a single instrument. For example, to utilize either of the plugger elements, the dental practitioner needs only to slightly rotate the tool about the longitudinal axis. Yet, the two pluggers are arcuately spaced apart from each other such that they do not interfere with each other. Furthermore, another tool utilized frequently with pluggers and burnishers, a blade member, is provided on the same instrument. Finally, the acorn carver is positioned proximate the blade for maximum efficiency.

It is contemplated that the tools of the present instrument can be rearranged between the first and second ends. For example, the acorn carver and the burnisher can be moved to opposing sides. Additionally, one plugger can be swapped with a blade. Additionally, the blade may be supplemented with a plurality of blades.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A dental instrument comprising:
a handle member having a first end and a second end;
a first tool assembly positioned at the first end and a second tool assembly positioned at the second end,
wherein the first tool assembly and the second tool assembly collectively include at least five separate dental tools.

2. The dental instrument of claim 1 wherein the dental tools are selected from the group consisting of: burnishers, plugger elements, acorn carvers, and blades.

3. The dental instrument of claim 1 wherein the first tool assembly further comprises a plurality of plugger elements.

4. The dental instrument of claim 3 wherein at least one of the plugger elements includes a first end extending from the handle member and a second end spaced apart from the handle member, at least a portion of the plugger element having an outwardly conical configuration proximate the first end of the plugger element and at least a portion of the plugger element having an inwardly conical region proximate the second end of the plugger element.

5. The dental instrument of claim 5 wherein the plugger element terminates with a convex cap at the second end thereof.

6. The dental instrument of claim 4 wherein the outwardly conical configuration comprises approximately 30% to 60% of the length of the plugger element, and the inwardly conical configuration comprises approximately 40% to 70% of the length of the plugger element.

7. The dental instrument of 3 wherein the first tool assembly further comprises two plugger elements, each of the plugger elements includes a first end extending from the handle member and a second end spaced apart from the handle member, at least a portion of the plugger element having an outwardly conical configuration proximate the first end of the plugger element and at least a portion of the plugger element having an inwardly conical region proximate the second end of the plugger element.

8. The dental instrument of claim 7 wherein the two plugger elements define a plane, the two plugger elements are angled relative to each other in the plane approximately between 65° and 125°.

9. The dental instrument of claim 7 wherein a first of the two plugger elements has an inwardly conical region which at a largest diameter is smaller than the diameter of the inwardly conical region of a second of the two plugger elements at a largest diameter.

10. The dental instrument of claim 7 wherein one of a burnisher and an acorn carver is positioned at a base of the two plugger elements, wherein the two plugger elements extend away from same.

11. The dental instrument of claim 7 wherein the first tool assembly further comprises a first tool arm extending from the handle, the first tool arm having a first segment and a second segment, the first segment being angled relative to the handle member and the second segment being angled relative to the first segment.

12. The dental instrument of claim 11 wherein the handle member, the first segment and the second segment define a plane, distinct from a plane defined by either of the two plugger elements.

13. The dental instrument of claim 3 wherein the second tool assembly further comprises a blade.

14. The dental instrument of claim 13 wherein the second tool assembly further comprises one of an acorn carver and a burnisher positioned at a base of the blade.

15. The dental instrument of claim 13 wherein the blade defines a plane which is oblique to the planes defined by any one of the plurality of plugger elements.

16. A dental instrument comprising:
a handle member; and
at least one plugger element comprising:
a first end extending from the handle member; and
a second end spaced apart from the handle member,
wherein at least a portion of the plugger element has an outwardly conical configuration proximate the first end thereof and at least a portion of the plugger element has an inwardly conical region proximate the second end thereof.

17. The dental instrument of claim 16 wherein the at least one plugger element terminates with a convex cap at the second end thereof.

18. The dental instrument of claim 16 wherein the outwardly conical configuration comprises approximately 30% to 60% of the length of the plugger element, and the inwardly conical configuration comprises approximately 40% to 70% of the length of the plugger element.

19. A dental instrument comprising:
a handle member having a first end;
a first tool assembly extending from the first end, the first tool assembly comprising at least two plugger elements, the at least two plugger elements extending away from each other, wherein each plugger element can be selectively used by a user substantially without interference from the other plugger element.

20. The dental instrument of claim 19 wherein the first tool assembly includes a first tool arm extending from the handle member, wherein a plane defined by the at least two plugger elements is oblique to the plane defined by the handle member and the first tool arm.
